(19) United States
(12) Patent Application Publication
(10) Pub. No.: US 2013/0020038 A1
(43) Pub. Date: Jan. 24, 2013

(54) SPRING ASSEMBLY

(71) Applicants: Antony Barnes, Stockport (GB); Andrew Greening, Sandbach (GB)

(72) Inventors: Antony Barnes, Stockport (GB); Andrew Greening, Sandbach (GB)

(73) Assignee: LOUVER-LITE LIMITED, Hyde, Cheshire (GB)

(21) Appl. No.: 13/638,339

(22) PCT Filed: Apr. 5, 2011
(86) PCT No.: PCT/GB11/00523

§ 371 Date: Oct. 4, 2012

(30) Foreign Application Priority Data
Apr. 6, 2010 (GB) 1005709.9

(51) Int. Cl. E06B 9/60; B23P 11/00; E06B 9/40; B65H 75/48; F03G 1/00

(52) U.S. Cl. 160/294; 185/45; 242/384.7; 29/428

(57) ABSTRACT

A spring assembly for a roller blind, the assembly including a stationary end, a rotatable end and a spring arrangement located therebetween which is connected at a first end thereof to the stationary end and at a second end thereof to the rotatable end, wherein the rotatable end includes a rotatable body which is adapted to rotate relative to a fixed body about a rotational axis, and wherein the spring assembly further includes a locking pin coupled to the fixed body such that it has a locked configuration in which it engages a portion of the rotatable body and prevents rotation of the rotatable body relative to the fixed body and a free configuration in which rotation of the rotatable body relative to the fixed body is permitted.

The present invention relates to a spring assembly and, in particular, to a spring assembly for use in a roller blind.

Roller blinds often include a spring assembly to store energy which is then used to assist with the raising of the blind. This is particularly true of relatively large blinds or blinds which utilise a relatively heavy fabric. In practice, the spring is tensioned when the blind is lowered and gravity is assisting the user. This energy is then stored in the spring until the blind is raised, whereupon the energy is released as the blind is raised, thereby assisting the user to raise the blind. In such blinds, the spring typically includes a pre-determined amount of energy stored therein when the blind is in the fully raised position. It is this energy which must be imparted to the spring to pre-tension the blind for use.

Typically, the spring assembly is supplied to the blind installer in a non-tensioned state and the installer must pre-tension the spring during the installation process. However, many installers are not skilled in providing the correct tension to the spring and often the spring is provided with the incorrect pre-tension during installation, which can result in problems when operating the blind and/or can cause premature wear of certain components within the blind.

Providing a vehicle blind in a pre-tensioned condition is known from U.S. Pat. No. 7,082,983. However, this document teaches that once the tension is released for the first time, the locking mechanism is permanently disengaged.

According to a first aspect, the present invention provides a spring assembly for a roller blind, the assembly including a stationary end, a rotatable end and a spring arrangement located therebetween which is connected at a first end thereof to the stationary end and at a second end thereof to the rotatable end, wherein the rotatable end includes a rotatable body which is adapted to rotate relative to a fixed body about a rotational axis, and wherein the spring assembly further includes a locking pin coupled to the fixed body such that it has a locked configuration in which it engages a portion of the rotatable body and prevents rotation of the rotatable body relative to the fixed body and a free configuration in which rotation of the rotatable body relative to the fixed body is permitted.

The locking pin is adapted to be moved between the locked configuration and the free configuration as desired. Thus, the invention allows for the locking pin to be engaged and released from the rotatable body as appropriate. The spring arrangement according to the invention may therefore be provided as a pre-tensioned unit for installation and the tension may be maintained in the spring assembly should the blind need to be dis-assembled, say for cleaning or maintenance, and then re-assembled.

The skilled person will appreciate that the spring arrangement may comprise a single spring with opposed free ends or it may comprise two or more springs connected together such that the arrangement as a whole has opposed free ends. An example of such a multi-spring arrangement is disclosed in EP 1947288. It is these opposed free ends which are connected respectively to the stationary end and the rotatable end.

It will also be appreciated that where it is stated that the rotatable end includes a rotatable body, this includes both the rotatable body forming a part of the rotatable end and a rotatable body being connected to the rotatable end via one or more intermediate elements.

In an embodiment of the invention as defined anywhere herein, the locking pin is slidably carried within a channel defined by the fixed body. The pin typically includes a pair of opposed end-stop elements which limit the movement of the locking pin within the channel and prevent removal of the locking pin from the channel. For example, the locking pin may include at one end thereof a pair of resiliently deformable legs, each carrying a lug at the distal end thereof, which allows the locking pin to be inserted into the channel, but prevents its removal therefrom. Such a snap-fit arrangement is well known to those skilled in the art.

Additionally or alternatively, the locking pin may comprise a substantially cylindrical body portion having a first diameter and a flange or an end cap having a greater diameter than the first diameter, such that the first diameter (i.e. that of the body portion) is less than the diameter of the channel, but the diameter of the flange or end cap is greater than the diameter of the channel.

In a further embodiment of the invention as defined anywhere herein, the channel defined by the fixed body is a radial channel relative to the rotational axis of the rotatable body. In other words, in this embodiment, the locking pin is slidable radially relative to the rotatable body which rotates about the rotation axis.

The fixed body may define a bearing wherein the rotatable body rotates relative to the fixed body within the bearing. The bearing in this embodiment may be a cylindrical aperture through the fixed body. In such an embodiment, the locking pin suitably engages a peripheral edge portion of the rotatable body, for example, one or more recesses defined by the peripheral edge portion.

In a further embodiment, the fixed body defines a bearing, within which is rotatably coupled the rotatable body, and a radial channel, within which is slidably coupled the locking pin, wherein the locking pin is adapted to engage one or more recesses defined by the peripheral edge portion of the rotatable body. Suitably, the locking pin extends outwardly beyond the fixed body. In other words, the channel suitably extends through the fixed body from the bearing edge portion to the radially opposite edge portion.

In an alternative embodiment, the rotatable body is arranged concentrically about the fixed body. Thus, the fixed body may act as a stationary axle for the rotatable body.

In a further embodiment of the invention, the fixed body may comprise the stationary end of the spring assembly. In such an embodiment, the first end of the spring arrangement is secured to the fixed body, either directly or via an intermediate element, to form the stationary end of the spring assembly and the second end of the spring arrangement may be connected to the rotatable body either directly or via an intermediate element.

Thus, the stationary end of the spring arrangement may be connected to the fixed body via the intermediate element, for example, via a rod.

Accordingly, the spring assembly may include a roller tube adapted to house therein at least the spring arrangement. Suitably, the roller tube houses therein the spring arrangement and the stationary end and the roller tube is connected, either directly or indirectly, to the rotatable body. In such an embodiment, the rotatable end of the spring assembly may include a bush located between the spring arrangement and the roller tube such that relative rotation between the roller tube and the second end of the spring arrangement is prevented.

The spring assembly defined above is for use with a roller blind. Accordingly, a second aspect of the invention provides a roller blind assembly including the spring assembly as defined anywhere herein. Thus, the roller blind assembly may further include a roller tube, a sheet of blind fabric, a control end, an idle end and/or a pair of brackets.

In an embodiment of the second aspect of the invention, the rotatable body is operably connected to a winding mechanism. The winding mechanism is typically part of the control end of the blind. Thus, when extending (i.e. deploying) the blind, the winding mechanism of this embodiment will have the dual function of unwinding a blind fabric from a roller tube and energising the spring arrangement. Similarly, when retracting the blind, the winding mechanism winds the blind fabric back onto the roller tube and releases energy stored in the spring arrangement.

In a further embodiment, the fixed body is secured to a mounting bracket. Typically, the stationary end of the spring assembly will be connected to the fixed body. Thus, in such embodiments, the stationary end of the spring assembly will be connected, via the fixed body, to a mounting bracket.

A third aspect of the invention provides a method of installing a roller blind, the method including:
i. installing a spring assembly as defined above into a roller blind tube;
ii. arranging the locking pin in the free configuration;
iii. rotating the rotatable body relative to the fixed body until the desired energy is stored in the spring arrangement;
iv. moving the locking pin to the locked configuration;
v. securing the roller blind tube to a pair of mounting brackets; and
vi. moving the locking pin to the free position.

Suitably, steps (i) to (iv) will be carried out by the blind manufacturer. As such, a further aspect of the invention provides a roller blind in kit form, wherein the kit includes a spring assembly as defined anywhere in the first aspect of the invention in a pre-tensioned configuration.

In an alternative embodiment, the spring assembly may be pre-tensioned prior to being inserted into the roller blind tube. Thus, the method may include the steps:
i. arranging the locking pin of a spring assembly as defined above in the free configuration;
ii. rotating the rotatable body relative to the fixed body until the desired energy is stored in the spring arrangement;
iii. moving the locking pin to the locked configuration;
iv. installing the pre-tensioned spring assembly into a roller blind tube;
v. securing the roller blind tube to a pair of mounting brackets; and
vi. moving the locking pin to the free position.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

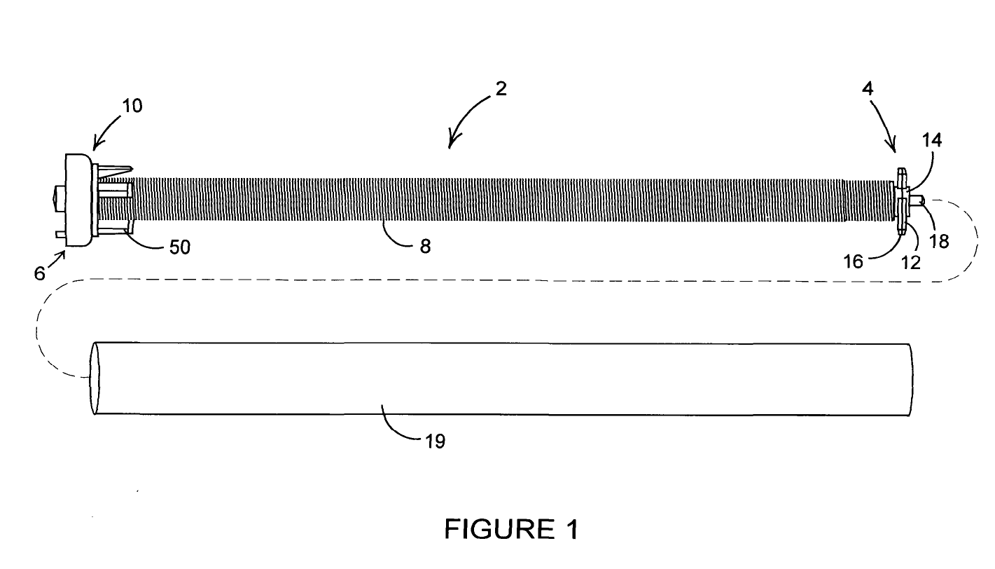

FIG. 1 is a side elevation view of a spring assembly and a roller tube according to the first aspect of the invention;

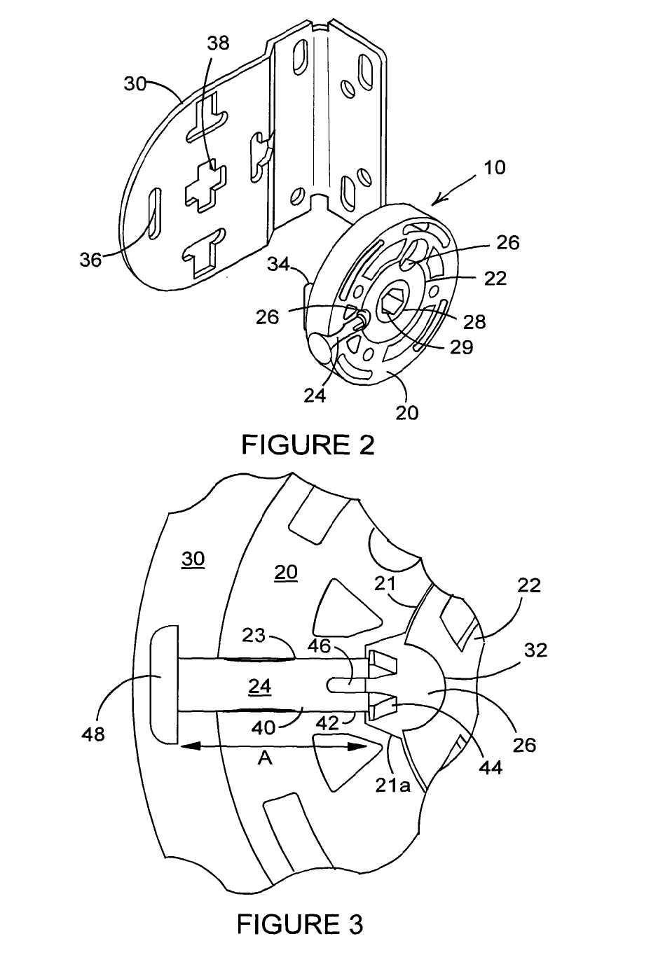

FIG. 2 is a perspective view showing the bearing and locking pin arrangement; and

FIG. 3 is side elevation view of the locking pin in relation to the bearing.

For the avoidance of doubt, the skilled person will appreciate that in this specification, the terms “up”, “down”, “front”, “rear”, “upper”, “lower”, “width”, etc. refer to the orientation of the components as found in the spring assembly when installed for normal use as shown in the Figures.

FIG. 1 shows a spring assembly 2 in accordance with the first aspect of the invention. A stationary end 4 is provided at one end of the assembly 2 and a rotatable end 6 is provided at the other end. A spring 8 is located between the rotatable end 6 and the stationary end 4.

Located at the rotatable end 6 of the assembly 2 is a bearing arrangement 10 which is shown in more detail in FIGS. 2 and 3 and described in detail below.

The spring assembly 2 includes a rod (not shown) which is located within the spring 8. The rod projects beyond the spring 8 at the stationary end 4 and terminates in an idle end pin 18.

Located at the stationary end 4 is a bush 12 rotatably coupled to the rod such that the rod forms a fixed axle for the bush 12. The bush 12 includes a flange 16 which is sized to fit within a roller tube 19. The flange 16 is provided with peripheral notches 14 arranged to engage with inwardly projecting ribs carried by the roller tube 19. This arrangement prevents the roller tube 19 rotating relative to the bush 12. Thus, the end of the roller tube 19 located in use at the stationary end of the spring assembly 2 is supported by the bush 12 and is capable of rotating relative to the stationary end of the spring 8.

Turning now to FIGS. 2 and 3, the bearing arrangement 10 will now be described in more detail. The bearing 10 includes a fixed body 20 which defines centrally therein a cylindrical bore having a bearing surface 21. Located within the cylindrical bore is an annular rotatable body 22 arranged concentrically about a fixed central axle 28.

The fixed body 20 and the fixed central axle 28 are prevented from rotating by securing lugs (one of the securing lugs 34 for the fixed body 20 is shown in FIG. 2, but the other lugs are not shown), which cooperate with corresponding apertures 36, 38 in a mounting bracket 30 to prevent rotation relative to the mounting bracket 30. However, the rotatable body 22 is free to rotate within the cylindrical bore about the fixed central axle 28.

The rod is secured to the fixed central axle 28 via a bore 29 having a hexagonal cross section. This arrangement prevents rotation of the rod relative to the fixed central axle 28.

The rotatable end of the spring 8 is secured to the rotatable body 22 such that rotation of the rotatable body 22 causes a corresponding rotation of the rotatable end of the spring 8.

The other end of the spring 8 (i.e. the stationary end of the spring) is connected to the rod, which in turn is connected to the fixed central axle 28 and as such is prevented from rotating.

When fully assembled, the rotatable body 22 is connected to a winding mechanism (not shown) which rotates the rotatable body 22 in the desired direction. It is also connected to a drive bush 50 which is sized to fit within the roller tube 19 and configured to engage one or more inwardly facing ribs. Thus, one end of the roller tube 19 is supported by the bush 50 and the other end of the roller tube 19 is supported by the bush 12. Such a drive arrangement for the roller tube 19 is well known to a person skilled in the art of roller blinds and will not be discussed in detail herein.

As well as defining the cylindrical bore 21, the fixed body 20 defines a locking pin channel 23 within which is located a locking pin 24. This arrangement is shown in more detail in FIG. 3.

The channel is arranged radially with respect to the rotational axis defined by the rotatable body 22. It extends through the fixed body 20 from the outer peripheral surface to a notch 21a formed in the bearing surface 21. Thus, the locking pin 24 extends through the fixed body 20 and projects radially inwardly and outwardly from it.

The locking pin 24 includes a cylindrical body 40 which terminates at a first end in a pair of opposed resiliently deformable legs 42 defining therebetween a gap 46. Each of the legs includes a respective lug 44 at the distal end thereof. This sort of a snap fit arrangement is well known in the art and allows the pin to be inserted into the channel 23 via inward deflection of the legs 42. Once the legs 42 are clear of the channel 23, they snap back to their rest position and the lugs 44 resist removal of the locking pin 24 from the channel 23. The lugs 44 therefore form a first stop element which functions to prevent removal of the locking pin 24 from the channel 23.

At the other end of the locking pin 24 is a flared cap 48 having a diameter which is greater than the diameter of the channel 23 and so forms a second stop element.

According to this arrangement, the locking pin 24 is captive within the channel 23, but is capable of sliding within the channel 23 in a radial direction A relative to the rotational axis.

The rotatable body 22 includes an outer peripheral surface 32 which defines therein three circumferentially spaced recesses 26. The recesses 26 are sized and configured to receive therein a portion of the legs 42 of the locking pin 24.

In use, the stationary end 4, together with the bush 12 and the spring 8 is inserted into the roller tube 19 until the drive bush 50 engages the end of the roller tube 19. The locking pin 24 is moved to a free position in which the lugs 44 are located in the notch 21a and out of the recess 26 of the rotatably body 22. The rotating body 22 is then rotated relative to the fixed body 20.

Rotation of the rotatable body 22 causes corresponding rotation of the drive bush 50, which in turn causes rotation of the roller tube 19. Rotation of the rotatable body 22 also causes rotation of the rotatable end of the spring secured thereto. The rotation of the roller tube 19 causes a corresponding rotation of the bush 12 relative to the rod, which is fixed against rotation. The rotatable end of the spring 8 which is connected to the rotatable body therefore rotates relative to the stationary end of the spring 8, which is secured to the rod at the stationary end 4 of the assembly. This imparts energy to the spring which is stored therein.

When the desired energy is stored in the spring, the rotation of the rotatable body 22 is ceased and the locking pin is moved radially inwards until the lugs 44 engage the recess 26 (i.e. a locked configuration). With the lugs 44 of the locking pin 24 engaging the recess 26 of the rotatable body 22, the rotatable body 22 is fixed to the fixed body 20 and is prevented from rotation relative thereto.

The installer is then able to install the blind with the spring assembly pre-tensioned. Once the blind is installed and the roller tube 19 is located within a pair of opposed mounting brackets 30, the locking pin 24 can be moved back to the free position and the blind can be used as normal.

1. A spring assembly for a roller blind, the assembly including a stationary end, a rotatable end and a spring arrangement located therebetween which is connected at a first end thereof to the stationary end and at a second end thereof to the rotatable end, wherein the rotatable end includes a rotatable body which is adapted to rotate relative to a fixed body about a rotational axis, the spring assembly further including a locking pin coupled to the fixed body such that it has a locked configuration in which it engages a portion of the rotatable body and prevents rotation of the rotatable body relative to the fixed body and a free configuration in which rotation of the rotatable body relative to the fixed body is permitted, wherein the locking pin is slidably carried within a channel defined by the fixed body and the locking pin includes a pair of opposed end stop elements which are adapted to limit the movement of the locking pin within the channel and to prevent removal of the locking pin from the channel.

2. A spring assembly according to claim 1, wherein the channel defined by the fixed body is a radial channel relative to the rotational axis.

3. (canceled)

4. A spring assembly according to claim 1, wherein the fixed body defines a bearing and the rotatable body rotates within the bearing.

5. A spring assembly according to claim 4, wherein the rotatable body is arranged concentrically about the fixed body.

6. A spring assembly according to claim 1, wherein the assembly further includes a roller tube and the spring arrangement is located within the roller tube.

7.-10. (canceled)

11. A roller blind including a roller tube and a spring assembly located within the roller tube, the spring assembly including a stationary end, a rotatable end and a spring arrangement located therebetween which is connected at a first end thereof to the stationary end and at a second end thereof to the rotatable end, wherein the rotatable end includes a rotatable body which is adapted to rotate relative to a fixed body about a rotational axis, the spring assembly further including a locking pin coupled to the fixed body such that it has a locked configuration in which it engages a portion of the rotatable body and prevents rotation of the rotatable body relative to the fixed body and a free configuration in which rotation of the rotatable body relative to the fixed body is permitted, wherein the locking pin is slidably carried within a channel defined by the fixed body and the locking pin includes a pair of opposed end stop elements which are adapted to limit the movement of the locking pin within the channel and to prevent removal of the locking pin from the channel.

12. A roller blind according to claim 11, wherein the roller blind further includes a winding mechanism and the winding mechanism is operably connected to the rotatable body.

13. A roller blind according to claim 11, wherein the roller blind further includes a pair of mounting brackets and the fixed body is secured to one of the mounting brackets in use.

14. A method of installing a roller blind, the method including:
i. installing a spring assembly into a roller blind tube, wherein the spring assembly includes a stationary end, a rotatable end and a spring arrangement located therebetween which is connected at a first end thereof to the stationary end and at a second end thereof to the rotatable end, wherein the rotatable end includes a rotatable body which is adapted to rotate relative to a fixed body about a rotational axis, the spring assembly further including a locking pin coupled to the fixed body such that it has a locked configuration in which it engages a portion of the rotatable body and prevents rotation of the rotatable body relative to the fixed body and a free configuration in which rotation of the rotatable body relative to the fixed body is permitted, wherein the locking pin is slidably carried within a channel defined by the fixed body and the locking pin includes a pair of opposed end stop elements which are adapted to limit the movement of the locking pin within the channel and to prevent removal of the locking pin from the channel;
ii. arranging the locking pin in the free configuration;
iii. rotating the rotatable body relative to the fixed body until the desired energy is stored in the spring arrangement;
iv. moving the locking pin in the locked configuration;
v. securing the roller blind tube to a pair of mounting brackets; and
vi. moving the locking pin to the free position.
